(19) United States
(12) Patent Application Publication
(10) Pub. No.: US 2015/0203391 A1
(43) Pub. Date: Jul. 23, 2015

(54) METHOD TO REMOVE AMMONIA FROM MINE DEPRESSURIZATION WATER

(71) Applicant: SYNCRUDE CANADA LTD. in trust for the owners of the Syncrude Project, Fort McMurray (CA)

(72) Inventors: DALLAS HEISLER, Beaumont (CA); GAIL BUCHANAN, Fort McMurray (CA); WARREN ZUBOT, Edmonton (CA)

(73) Assignee: SYNCRUDE CANADA LTD. in trust for the owners of the Syncrude Project, Fort McMurray (CA)

(21) Appl. No.: 14/161,542

(22) Filed: Jan. 22, 2014

(51) Int. Cl. C02F 9/00; C02F 1/66; C02F 1/32; C02F 1/78; C02F 1/20

(52) U.S. Cl. CPC C02F 9/00; C02F 1/78; C02F 1/20; C02F 1/32; C02F 1/66

(57) ABSTRACT

The invention is directed to a process for removing ammonia from mine depressurization water involving introducing the water into a tank or collection pond; injecting a sufficient amount of an oxidizing gas into the water to yield aerated water; and holding the aerated water within the tank or collection pond for a pre-determined residence time to perform air-stripping on the aerated water to facilitate the volatilization of ammonia; nitrification to convert ammonia into nitrate and nitrite; or both.

### FIELD OF THE INVENTION

The present invention is directed to a method of removing ammonia from mine depressurization water.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules. The Athabasca oil sand deposits may be efficiently extracted by surface mining which involves shovel-and-truck operations (for example, mining shovels and hydraulic excavators). In mining operations, dewatering processes are required to lower the water table within and outside the mine to prevent flooding and the subsequent destabilization of mine walls and slopes, collapse of materials into the slope, and saturation of materials to be excavated. To maintain dry conditions, dewatering may be achieved by pumping from dewatering wells outside the mine and by installing pumps in sumps and wells on the mine floor.

The water which is removed in association with dewatering operations must be handled in an appropriate manner to minimize environmental impacts. The quality of the water is assessed to determine the need for treatment before discharge to tailings or surface water bodies. Surficial water includes run-off water and shallow aquifer water which are relatively fresh. However, a major source of the water arises from the “basal aquifer” which refers to water-bearing sands and gravel, generally located at the bottom of the lower McMurray formation, underlying the bitumen-saturated sands. The water is fresh to brackish to saline (depending on the location of the aquifer), with methane, sulfide, ammonia and carbon dioxide.

Discharge limits for mine depressurization water are set with the objective of protecting the environment. While sulphide and ammonia have regulated maximum discharge limits, dissolved oxygen is regulated as a minimum. To reduce the potential for formation of hazardous hydrogen sulphide, sulphide may be oxidized to sulphate and degassed using for example, a diffusion system (Seair Diffusion Systems Inc., Edmonton, Alberta, Canada). Gas (for example, oxygen, ozone and/or carbon dioxide) is diffused into the water being passed through the system and creates microbubbles, allowing for the mass transfer of gas to the water to create a supersaturated fluid. The supersaturated fluid is reintroduced back towards its destination retaining 85% of the gas in a stable condition.

However, once the sulfide and oxygen criteria have been met, the water cannot yet be discharged to surface water bodies. Ammonia has limited reaction with oxygen and exists in equilibrium with ammonium ions (NH₃+H₂O [symbol] NH₄⁺+OH⁻). Below pH 7, ammonia is in the form of soluble ammonium ions. Above pH 12, ammonia is present as a dissolved gas. Between pH 7 to pH 12, both ammonia and ammonium ions exist together. The maximum daily average limit for total ammonia (free ammonia=NH₃+ionized ammonia=NH₄⁺) is 2.5 mg/L, and the weekly or monthly average limit is 1.0 mg/L.

Current methods for ammonia removal depend upon the specific application, initial ammonia concentrations, and the required level of reduction. As an example, depressurization water may be stored in a containment holding pond for about three days to allow natural processes such as biological nitrification to occur. Bacteria oxidize ammonia and ammonium ions to form nitrites and nitrates which can be absorbed by more complex organisms such as plants. However, there may be a need to reduce the average retention time which decreases the effectiveness of biological nitrification, and heterotrophic bacteria may inhibit the growth and activity of nitrifying bacteria. Compared to biological nitrification, ion exchange responds well to shock loads of ammonia and operates over a wider temperature range. Ion exchangers with high affinities for ammonium ions include polymeric exchangers, clinoptilolite and other natural zeolites.

Reverse osmosis involves forcing water through a semi-permeable membrane having pores through which water, but not impurities, may flow. Reverse osmosis is problematic since it is relatively slow, and allows passage of contaminants which may be molecularly smaller than water. Air stripping involves the transfer of volatile components of a liquid into an air stream. In the stripper, the water is distributed over the internal packing media to be broken up into droplets. Air enters the bottom of the tower and travels upward through the packing media. Since ammonia is partially present as a dissolved gas, some of the ammonia transfers from the water to the air. With an air stripper, the removal efficiency is limited by the operating temperature, and the recovered ammonia requires disposal. Similarly, steam stripping uses steam as a stripping gas to remove volatile components of a liquid at a temperature greater than 95° C., and requires an oxidative decomposition reactor to decompose ammonia gas into nitrogen and water.

Accordingly, there is a need in the art for an improved method of removing ammonia from mine depressurization water.

### SUMMARY OF THE INVENTION

The present invention relates to a method of removing ammonia from mine depressurization water.

In one aspect, the invention comprises a process for removing ammonia from mine depressurization water comprising:

introducing the water into a tank or collection pond;

injecting a sufficient amount of an oxidizing gas into the water to yield aerated water; and holding the aerated water within the tank or collection pond for a pre-determined residence time to perform air-stripping on the aerated water to facilitate the volatilization of ammonia; nitrification to convert ammonia into nitrate and nitrite; or both.

In one embodiment, the oxidizing gas comprises atmospheric air, pure oxygen, ozone, and mixtures thereof. In one embodiment, the oxidizing gas comprises ozone. In one embodiment, ozone is injected at a rate ranging between about 120 g/hr to about 360 g/hr.

In one embodiment, the process further comprises degassing the water prior to aeration.

In one embodiment, the process further comprises applying UV radiation to irradiate the water. In one embodiment, the UV radiation has a wavelength of about 245 nm.

In one embodiment, the process further comprises adjusting the pH of the water by addition of a base in a quantity sufficient to result in a pH of about 8.0.

In one embodiment, the residence time is at least about three hours.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 is a schematic of the setup for the bench-scale trials.

FIG. 2 is a graph showing the ammonia-nitrogen concentration (ppm) over time (min) for bench-scale Trial 1.

FIG. 3 is a graph showing the ammonia-nitrogen concentration (ppm) over time (min) for bench-scale Trial 2.

FIG. 4 is a graph showing the ammonia-nitrogen concentration (mg/L) over time (min) for bench-scale Trials 3 and 4.

FIG. 5 is a graph showing the ammonia-nitrogen concentration (mg/L) over time (min) for bench-scale Trials 3-5 at different pH values.

FIG. 6 is a graph showing the ammonia-nitrogen concentration (mg/L) over time (min) for bench-scale Trials 3-5 at different pH values with projected trendlines.

FIG. 7 is a graph showing the ammonia-nitrogen concentration (mg/L) over time (min) for pilot testing Run 1.

FIG. 8 is a graph showing the ammonia-nitrogen concentration (mg/L) over time (min) for pilot testing Run 2.

FIG. 9 is a graph showing the ammonia-nitrogen concentration (mg/L) at various time points for pilot testing Runs 1 and 2.

FIG. 10A is a schematic of a portable pilot unit.

FIG. 10B is a flow chart of a process using the pilot unit of FIG. 10A.

FIG. 11 is a graph showing the ammonia-nitrogen concentration (mg/L) at various time points during an advanced oxidation field trial.

FIG. 12 is a graph showing the ammonia-nitrogen concentration (mg/L) at various time points during an advanced oxidation field trial.

FIG. 13 is a graph showing the pH measured at various time points during an advanced oxidation field trial.

FIG. 14 is a graph showing the ammonia-nitrogen concentration (mg/L) measured at various time points during holding pond aeration.

FIG. 15 is a graph showing the total ammonia-nitrogen concentration (mg/L) in pre- and post-treated depressurization water (for pre-treated NH₃—N>1 mg/L).

### DETAILED DESCRIPTION OF PREFERRED EMBODIMENTS

When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

The present invention relates generally to processes of removing ammonia from mine depressurization water. In one aspect, the present invention relates to a process for removing ammonia from mine depressurization water to render it suitable for discharge to surface water bodies. To meet specification requirements, the maximum daily average limit for total ammonia (free ammonia=NH₃⁺ ionized ammonia=NH₄⁺) is 2.5 mg/L, and the weekly or monthly average limit is 1.0 mg/L.

The process generally involves introducing mine depressurization water into a tank or collection pond, and injecting a sufficient amount of an oxidizing gas into the water to yield aerated water. Aeration increases the concentration of dissolved oxygen within the water and volatizes a portion of the ammonia present therein. As used herein, the term “oxidizing gas” includes, but is not limited to, atmospheric air, pure oxygen, ozone, and mixtures thereof. In one embodiment, the oxidizing gas comprises ozone. In one embodiment, ozone is injected at a rate ranging between about 120 g/hr to about 360 g/hr.

Ammonia will release from solution at the gas-liquid interface, and is in a constant state of equilibrium (NH_{3(g)} [symbol] NH_{3(aq)} [symbol] NH_{4(aq)}). By increasing the surface area of the gas-water interface and constantly replenishing the gas, the equilibrium will shift to the gas phase, thereby removing ammonia from solution. Injection of oxidizing gas into the water forms microbubbles. A microbubble diffusion system produces over 1,000 times greater surface area than typical fine bubble diffusion and over 10,000 times greater surface area than typical coarse bubble aeration systems. Coupled with a sufficient residence time of the microbubbles, this increases the surface area and contact time available for diffusion. Ammonia-enriched microbubbles can be released from solution by splashing the water on a hard surface, allowing the bubbles to escape.

The aerated water is held within the tank or collection pond for a pre-determined residence time to perform air-stripping on the aerated water to facilitate the volatilization of ammonia; nitrification to convert ammonia into nitrate and nitrite; or both. In air stripping, a portion of the ammonia (NH_{3(g)}) is removed as the microbubbles dissipate. In nitrification, bacteria convert free ammonia to nitrite and nitrate (NH_{3(aq)}→NO⁻_{x(aq)}) which can be absorbed by more complex organisms such as plants.

As described in the Examples, bench-scale trials (Example 1), field-scale pilot tests (Example 2), field-scale advanced oxidation (Example 3), and pond-scale aeration (Example 4) were conducted to determine suitable processes for reducing the total ammonia (NH₃—N) in mine depressurization water from the Aurora North Mine (Syncrude Canada Ltd.).

Bench-scale trials were conducted to assess the efficiency of ammonia oxidation using ozone/UV advanced oxidation. Ammonia oxidation is dependent upon the formation of the hydroxyl radical (OH.), the neutral form of the hydroxide ion. The hydroxyl radical is a relatively strong oxidant which is produced through the decomposition of ozone with UV light. Advanced oxidation provides multiple reaction pathways in order to increase oxidation kinetics. The ozone/UV light system provides three possible mechanisms for the generation of the hydroxyl radical and three types of direct oxidation processes (i.e., direct ozonation, direct oxidation (H₂O₂), and direct photolysis). The hydroxyl radical and ozone react with free ammonia to form nitrate.

The bench-scale trials involved treating city tap water/ammonia mixtures with ozone/UV light. The results indicated a 29% reduction of NH₃—N in tap water at pH 6.85 which increased to 37% through pH adjustment to 8.27. A maximum of 41% was reached using a two-stage oxidation process with intermediary pH adjustment. A portable pilot unit was constructed within a 20 ft sea container to serve as an ozone supply unit and mobile lab for on-site instrument measurements, and to ensure that the results of the bench-scale trials were reproducible at a larger scale. Similar results as observed in the bench-scale trials were obtained for the pilot-scale runs.

Two separate field trials were conducted to assess total ammonia (NH₃—N) reduction in mine depressurization water using two different techniques. Advanced oxidation involving ozone/UV light was applied to depressurization water from a well, while pond aeration using a microbubble diffusion tower was applied to depressurization water retained in a sump. Pond aeration using a microbubble diffusion tower was more effective than ozone/UV light treatment in reducing the total ammonia in depressurization water. Using pond aeration/microbubble technology, the total ammonia was reduced by an average of 30% between a four (4) month period of time compared to a 20.5% reduction on average of total ammonia during a seven (7) day period of time using the ozone/UV light treatment. Compared to ozone/UV light treatment, pond aeration is less complicated and inexpensive to implement and operate.

Exemplary embodiments of the present invention are described in the following Examples, which are set forth to aid in the understanding of the invention, and should not be construed to limit in any way the scope of the invention as defined in the claims which follow thereafter.

### Example 1

### Bench-Scale Trials

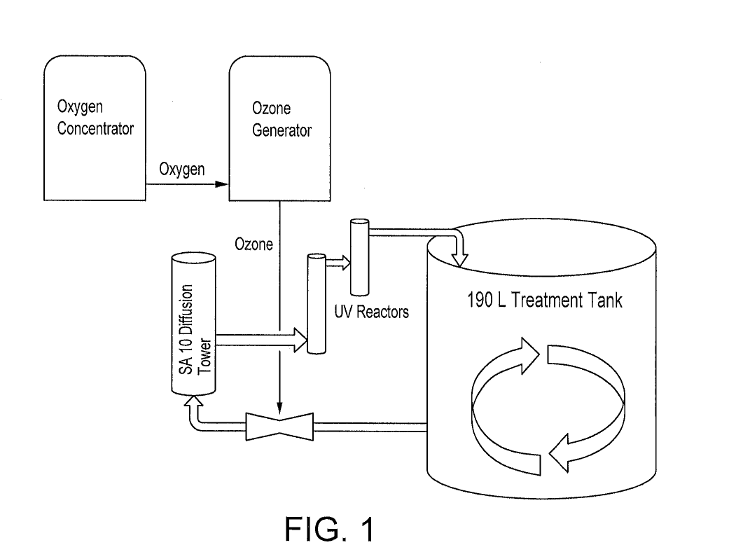

The set-up of the bench-scale trials using specific materials/equipment (Table 1) is shown in FIG. 1.

TABLE 1
Materials/Equipment for bench-scale trials

| Materials/Equipment | Specifications |
|---|---|
| SA 10 diffusion tower | Input - evacuates 21 LPM of gas |
| (Seair Diffusion Systems Inc.) | under normal conditions through |
| | the venture injector |
| | Flow rate - approximately up to |
| | 120 LPM |
| Two SmartUV Lite ™ 1.5″ | Size - 2″ diameter |
| UV flow-through vessels | Lamp power - 23 W |
| (Emperor Aquatics, Inc.) | Wavelength - 254 nm |
| Two Guardian ™ Model PB 30 | Output - continuously variable |
| ozone generators | up to about 36 g ozone/hr |
| (Guardian Manufacturing) | |
| Two AirSep ™ AS-12 oxygen | O₂ output - about 12 SCFH at |
| concentrators (AirSep Corporation) | minimum 90% purity |
| Treatment tank | |
| Household ammonia | |
| Ammonia testing reagents | |
| Hach ™ DR 2800 Spectrophoto- | |
| meter (Hach Company) | |
| HI 991002 Extended Range | |
| Waterproof pH/ORP/Temperature | |
| Meter (Hanna Instruments) | |

In Trial 1, 170 L of tap water (Edmonton, Canada) and 3.8 mL of household ammonia were added to the tank, and mixed by pumping for four minutes without air. The ozone generator (30 g/hr at 10% output) and UV lights were turned on. The water/ammonia mixture was continuously re-circulated at 95 L/min for 118 minutes. Samples were analyzed at specific time points for NH₃—N.

In Trial 2, 170 L of tap water and 8.6 mL of household ammonia were added to the tank, and mixed by pumping for four minutes. The ozone generator (30 g/hr at 100% output) and UV lights were turned on. The water/ammonia mixture was continuously re-circulated at 95 L/min for 85 minutes. Samples were analyzed at specific time points for NH₃—N.

In Trial 3, 170 L of tap water was added to the tank, and 14.0 mL of household ammonia was added while filling the tank. 25 mL of 1.0 mol/L NaOH was added with the pump circulating (pH was 8.27 after adjustment). The ozone generator (30 g/hr at 100% output) and UV lights were then turned on. The water/ammonia mixture was continuously re-circulated at 95 L/min for 105 minutes (about 0.31 g O₃/L fluid in final sample). Samples were analyzed at specific time points for NH₃—N.

In Trial 4, 170 L of tap water was added to the treatment tank, and 14.0 mL of household ammonia was added while filling the tank. The ozone generator (30 g/hr at 100% output) and UV lights were turned on. The water/ammonia mixture was continuously re-circulated at 95 L/min for 1 hour. Samples were analyzed at specific time points for NH₃—N.

In Trial 5, the final fluid from Trial 4 was used (advanced oxidation). 25 mL of 1.0 mol/L NaOH was added (pH was 8.06 after adjustment). The mixture was mixed with a small circulation pump. The ozone generator (30 g/hr at 100% output) and UV lights were turned on. The water/ammonia mixture was continuously re-circulated at 95 L/min for 1 hour. Samples were analyzed at specific time points for NH₃—N.

TABLE 2
Summary of Bench Scale Trials

| | | Fluid | Initial pH | Initial NH₃—N | Final NH₃—N | NH₃—N | NH₃—N % |
|---|---|---|---|---|---|---|---|
| | Starting | Volume | *estimated | Concentration | Concentration | Reduction | Reduction |
| Trial # | Fluid | (L) | pH | (mg/L) | (mg/L) | (mg/L) | (%) |
| Trial 1 | Tap water | 170 | ~6.9* | 0.762 | 0.384 | 0.378 | 49.7 |
| Trial 2 | Tap water | 170 | ~6.9* | 1.07 | 0.760 | 0.31 | 29.0 |
| Trial 3 | Tap water | 170 | 8.27 | 1.71 | 1.07 | 0.64 | 37.4 |
| Trial 4 | Tap water | 170 | 6.85 | 1.76 | 1.26 | 0.50 | 28.4 |
| Trial 5 | Trial 4 | 170 | 8.06 | 1.23 | 1.03 | 0.20 | 16.3 |
| | final fluid | | | | | | |
| Trials | Tap water | 170 | 6.85 | 1.76 | 1.03 | 0.73 | 41.5 |
| 4 & 5 | | | | | | | |

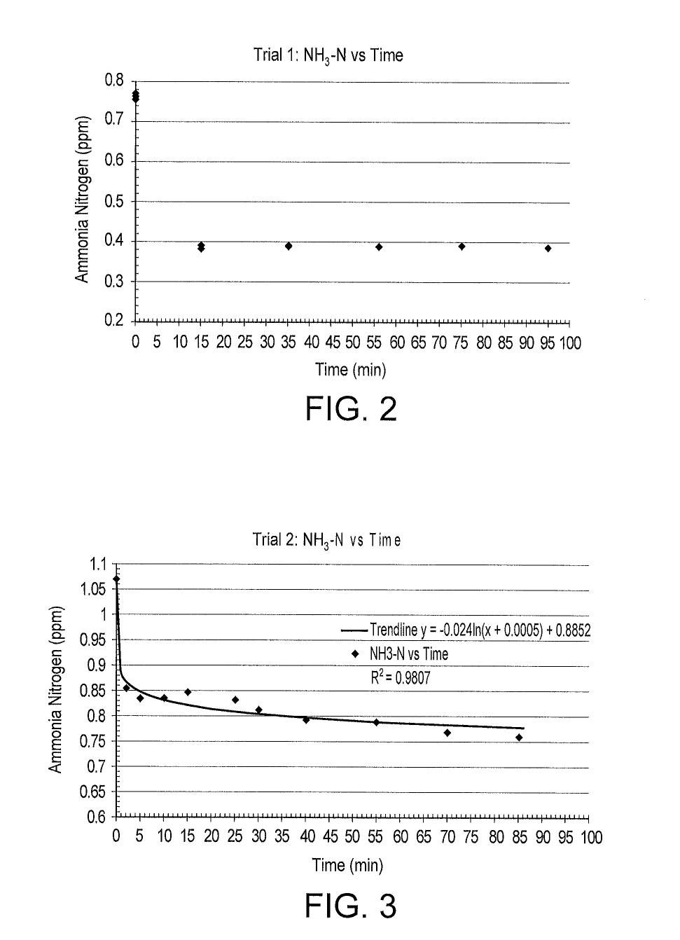

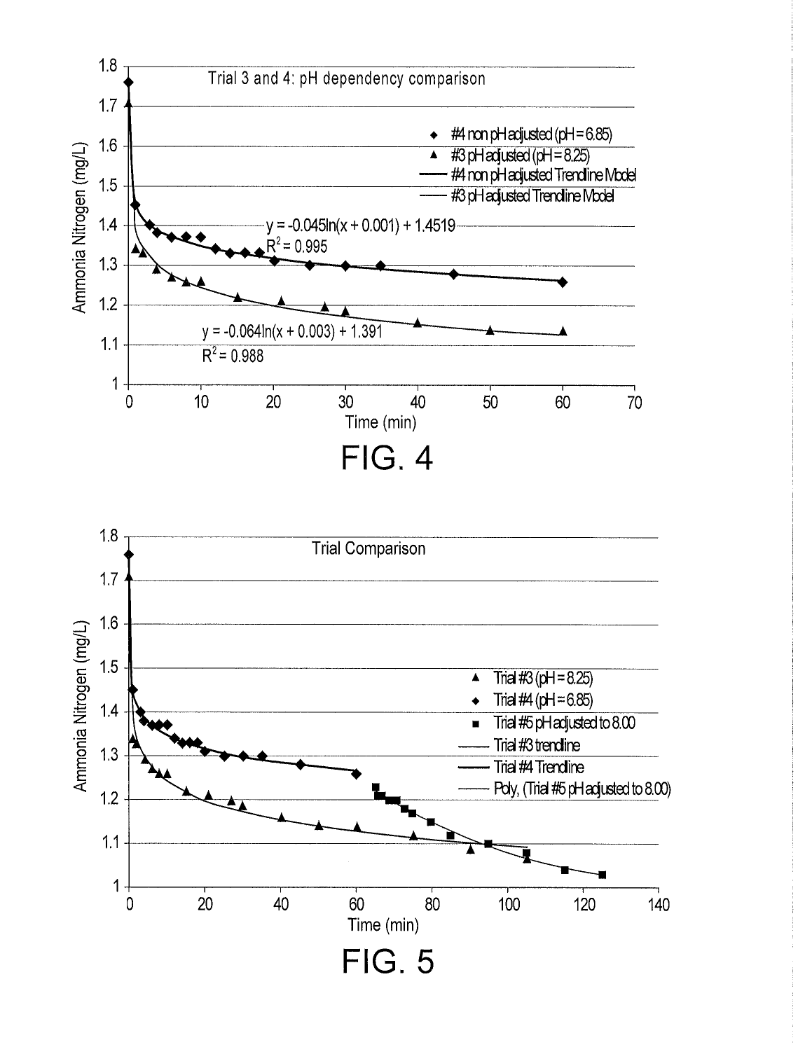

As shown in FIGS. 2-6, the results indicate that the ammonia-nitrogen concentration decreased rapidly until it leveled off and approached a lower limit, approximating a negative logarithmic function. The limit appears to depend upon the initial ammonia concentration and the pH of the water. Trial 3 assessed whether an elevated initial pH (8.27) might provide more free ammonia available for oxidation. Compared to Trial 3, Trial 4 shared a similar initial ammonia-nitrogen concentration but with advanced oxidation being conducted at the natural pH of water (6.85). Trial 5 attempted to re-create the initial accelerated oxidation rate by raising the pH in between separate advanced oxidation stages.

Trials 2 and 4 demonstrated a consistent ammonia-nitrogen decrease of about 28.4-29.0% using tap water at pH 6.85. In Trial 3, the ammonia-nitrogen removal efficiency was increased to 37.4% by adjusting the initial pH to 8.27. This corresponds to a theoretical initial ammonia/ammonium ratio of 10.7% at pH 8.27 versus 0.4% at pH 6.85. Since the ammonia-nitrogen removal rate (˜28-37% removal) is much greater relative to theoretical ammonia/ammonium ratio (0.4-10.7%), it is believed that the initial rapid decrease in the ammonia-nitrogen concentration may be due to the unbound ammonia oxidation. The equilibrium between NH₄⁺ and NH₃ is expected to be continually restored as the ammonia form is oxidized, resulting in greater removal rate than expected from the NH₃ concentration alone. Elevated pH levels resulted in increased absolute ammonia removal and percent removal (FIG. 5).

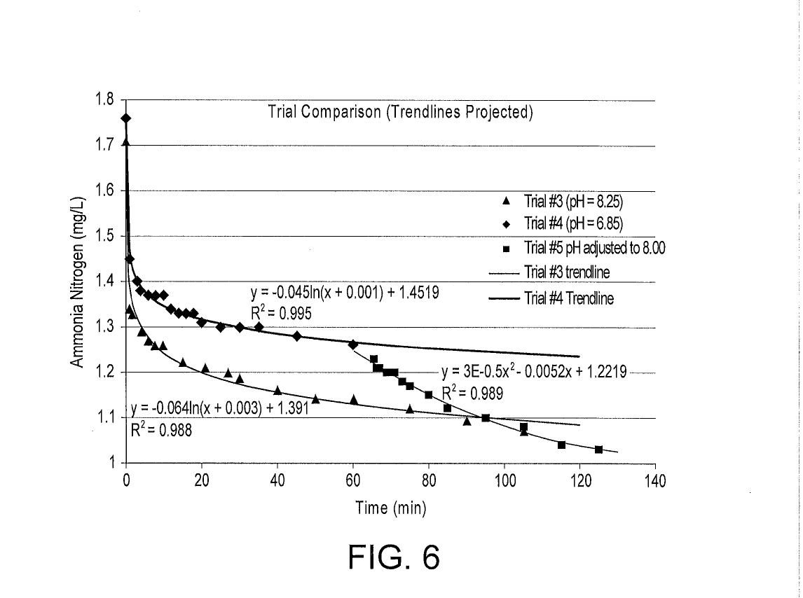

In Trial 5, the two stage oxidation process with pH adjustment between the stages yielded an overall ammonia-nitrogen decrease of 41.5% compared to 28.4% in Trial 4 which lacked pH adjustment. In Trial 5, the pH was adjusted to 8.06 to create more unbound ammonia and favorable conditions for advanced oxidation. Advanced oxidation was repeated, resulting in an additional significant decrease in the ammonia-nitrogen concentration. However, the ammonia versus time function for Trial 5 did not follow a negative logarithmic curve, but rather a shallow quadratic (FIG. 6).

The highest ammonia-nitrogen reduction (49.7%) occurred in Trial 1 which had a low initial ammonia concentration and low ozone dose rate. Without being bound by any theory, the low initial concentration might account for the higher reduction in Trial 1. Higher reduction at lower ozone doses may be due to the ozone forming complexes with the ammonium ion, causing it to be unavailable for re-establishing the natural ammonium-ammonia equilibrium after the unbound ammonia is consumed by advanced oxidation. This might explain the initial surge of ammonia removal that occurs in the first few minutes, as the ozone and oxygen concentration is low enough to prevent complexing with the ammonium form, but high enough to oxidize the unbound ammonia and unbound ammonium as it restores the equilibrium.

### Example 2

### Field-Scale Pilot Test

The components of the pilot unit are set out in Table 3.

TABLE 3
Components of Portable Pilot Unit

| Component | Specifications |
|---|---|
| SA 300 diffusion tower | Input - evacuates up to 930 LPM |
| (Seair Diffusion Systems Inc.) | of gas under normal conditions |
| | through the venture injector |
| | Flow rate - approximately up |
| | to 1360 LPM |
| DOCS 66 oxygen | Output - 66 LPM of oxygen at |
| concentrator (PCI) | 95% purity |
| | Type - Vacuum swing |
| | adsorption (VSA) |
| Guardian ™ Model PB 120 | Output - approximately 120 g/hr |
| and 240 ozone generators | and 240 g/hr of ozone through the |
| (Guardian Manufacturing) | use of pure oxygen supplied by |
| | either an oxygen concentrator or |
| | compressed oxygen cylinders |
| UV flow-through reactor | Size - 3″ diameter inlet/outlet |
| | Lamp power - 240 W |
| | Wavelength - 245 nm |
| Treatment tank | |
| 1750 US gallon contact tank | |
| Tangential flow vortex degasser | Size - 1″ diameter |
| (GDT Corporation) | Flow rate - 20-140 LPM water flow |

In Run 1, 3.7 m³ of tap water (Edmonton, Canada) was added to the tank, followed by addition of 215 mL of household ammonia. The ozone generator (360 g/hr at 100% output) and UV light were turned on. The water/ammonia mixture was continuously re-circulated at 1.25 m³/min for 87 minutes. Samples were analyzed at specific time points for NH₃—N.

In Run 2, 3.0 m³ of tap water was added to the tank, and 350 mL of household ammonia was added while filling the tank. The pump and UV/ozone generator (360 g/hr at 0% output) were turned on. The water/ammonia mixture was continuously re-circulated at 1.25 m³/min for 48 minutes (Run 2A). The ozone was dialed up to 100% output at 48 minutes. The water/ammonia mixture was continuously re-circulated at 1.25 m³/min for an additional 193 minutes (Run 2B). Samples were analyzed at specific time points for NH₃—N.

TABLE 4
Summary of Pilot Testing Trials

| | | Fluid | Initial pH | | Initial | Final | NH₃—N | NH₃—N % |
|---|---|---|---|---|---|---|---|---|
| | Starting | Volume | *estimated | Treatment | NH₃—N | NH₃—N | Reduction | Reduction |
| Trial # | Fluid | (m³) | pH | Process | (mg/L) | (mg/L) | (mg/L) | (%) |
| Run 1 | Tap water | 3.7 | ~6.9* | Advanced | 1.23 | 0.775 | 0.455 | 37 |
| | | | | oxidation | | | | |
| Run 2A | Tap water | 3.0 | ~6.9* | Control - | 2.02 | 2.01 | 0.01 | 0.5 |
| | | | | UV and O₂, | | | | |
| | | | | no O₃ | | | | |
| Run 2B | Run 2A final | 3.0 | ~6.9* | Advanced | 2.01 | 1.29 | 0.72 | 35.8 |
| | (tap water) | | | oxidation | | | | |

The pilot-scale unit was designed to deliver a smaller ozone dose (29-41% less ozone dose) at full output compared to the ozone doses for the bench-scale tests (Table 5).

TABLE 5
Summary of ozone doses for bench-scale and pilot-scale trials

| | |
|---|---|
| (360 g/hr)/3700 L = 0.10 g O₃/hr/L | Pilot-scale relative ozone dose |
| | (Run 1) |
| (360 g/hr)/3000 L = 0.12 g O₃/hr/L | Pilot-scale relative ozone dose |
| | (Run 2B) |
| (3 g/hr)/170 L = 0.02 g O₃/hr/L | Bench-scale relative ozone dose |
| | (Trial 1) |
| (30 g/hr)/170 L = 0.17 g O₃/hr/L | Bench-scale relative ozone dose |
| | (Trials 2-5) |

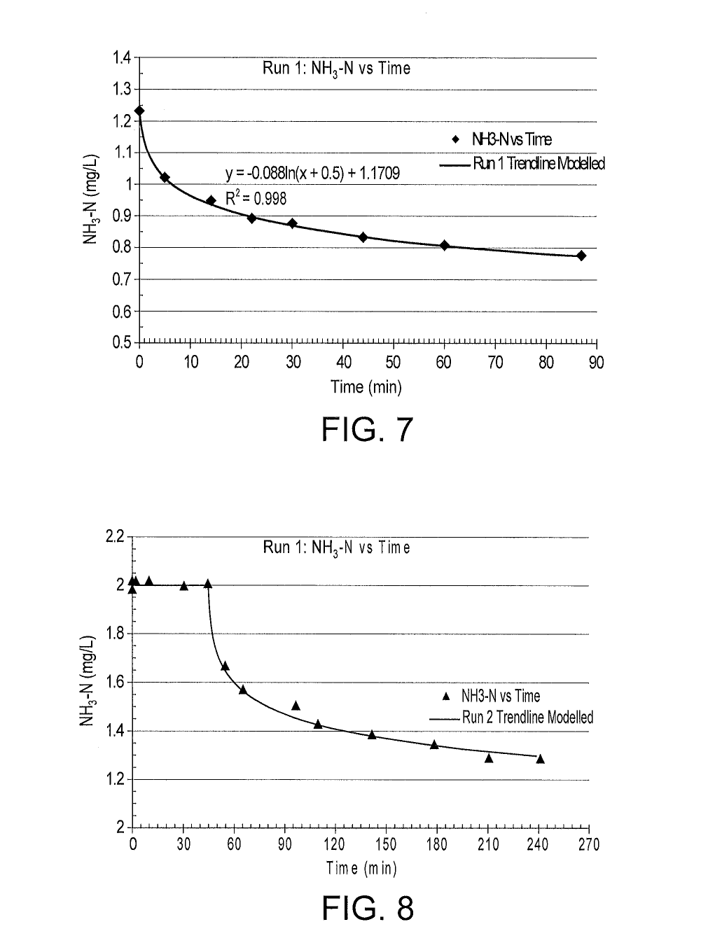

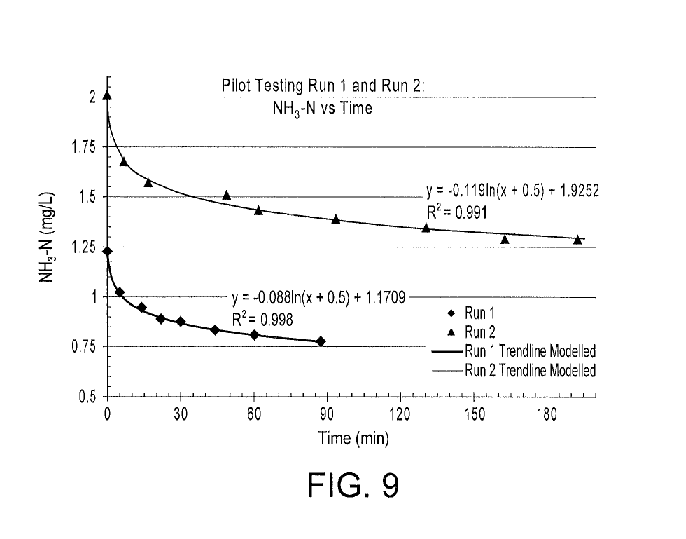

Similar results as observed in the bench-scale trials were obtained for the pilot-scale runs (Table 4; FIGS. 7-9). A 36-37% reduction in the ammonia-nitrogen was observed (Table 4), with a negative logarithmic oxidation curve (FIG. 9). Even with the lower ozone dose rate, the overall ammonia reduction in the pilot-scale run was more efficient than bench-scale Trials 2 and 4. Without being bound by any theory, these results suggest that excessive oxygen and ozone concentrations might hinder the ammonia oxidation reaction due to complexing of the ammonium.

For the first 48 minutes of Run 2, the entire system was operated with the UV and oxygen flow on, but the ozone rheostat dial turned to 0%. This corresponds to 0% ozone output, with oxygenation occurring only in the tank. Oxygenation and UV light alone were thus insufficient to remove any significant amount of ammonia (Table 4). Run 2A served as a control, and isolated ozonation as the crucial step in the chemical ammonia removal process.

### Example 3

### Field-Scale Advanced Oxidation

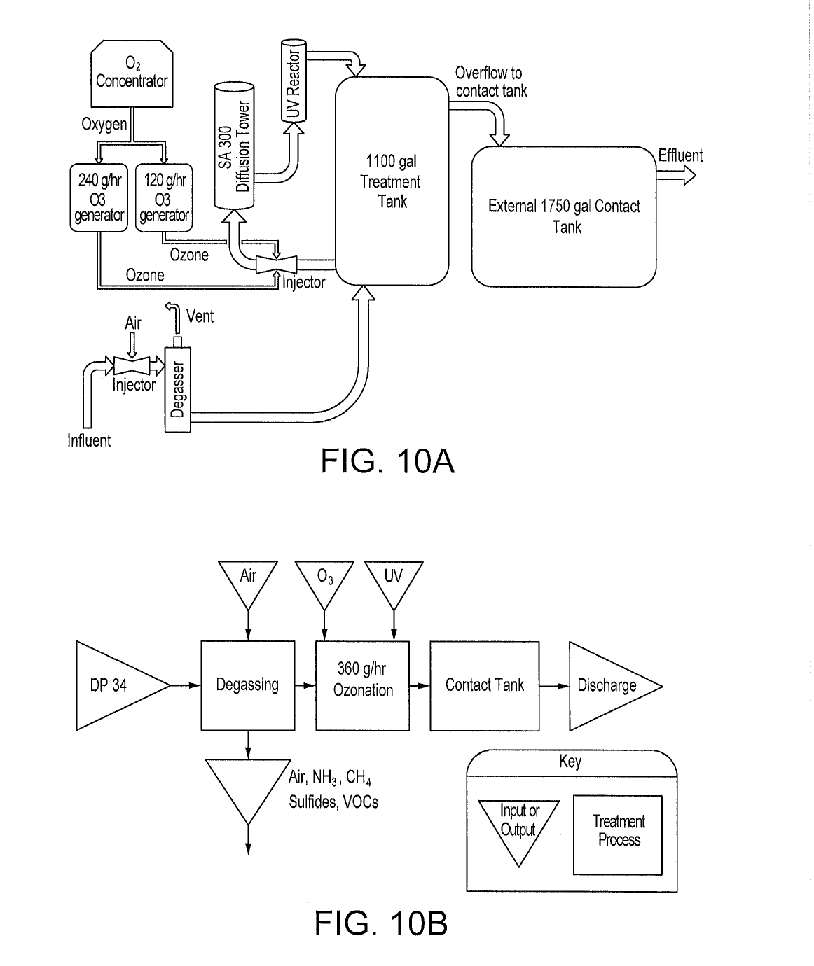

Advanced oxidation of ammonia was tested on-site at depressurization well #34 (“DP 34”) at the Aurora North mine (Syncrude Canada Ltd.). Water from DP 34 comes to a well head where the majority of the water is forced through a SA 300 diffusion tower (Seair Diffusion Systems Inc.) and released to a drainage ditch. The pilot treatment system draws a slip stream of water before the diffusion tower. The water in the slip stream is regulated to about 20 LPM and is forced through a venturi injector, where about 10 LPM of gas is drawn into the mode of flow of the water (FIGS. 10A-B). The water then enters a 1 inch tangential flow degasser with a density separation gas relief valve on top. The injected air and some dissolved gases are removed through the degasser. The water flows to a 200 L low profile life-station. The water fills the station and an on/off float level starts the transfer of water from the lift station to the 4.16 m³ reaction tank located within the portable pilot unit. The water enters the reaction tank at the intake to the 1.25 m³/min pump which recycles the water from the reaction tank through ozone injection, the SA 300 diffusion tower and a 240 W UV reactor. The ozone is fed to the reaction via a 3″ venturi injector, and originated from 240 g/hr and 120 g/hr plasma block ozone generators. The ozone generators are fed concentrated oxygen from the DOCS 66 VSA oxygen concentrator. The reaction occurs with residence time for approximately 220 minutes. The water then overflows from the reaction tank into the 6.62 m³ holding tank, which is float controlled to discharge water to a ditch.

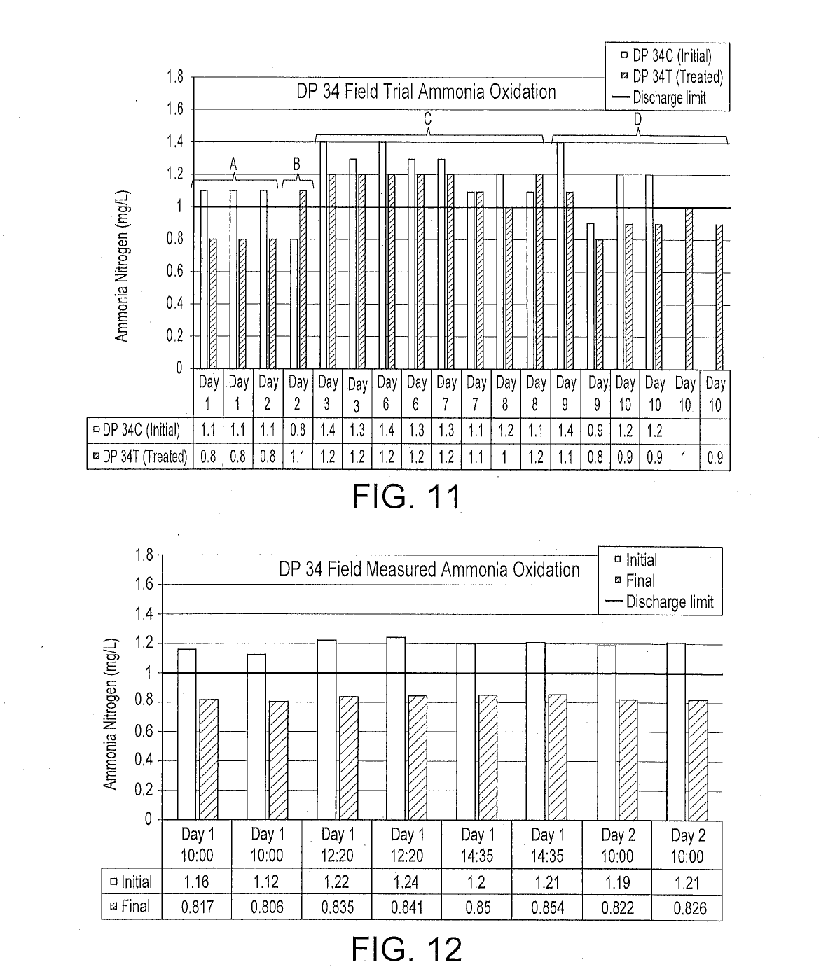

The data of FIG. 11 has been divided into Sections A-D. Sections A and D correspond to the periods that staff were on-site operating the equipment. The ammonia oxidation was much more efficient on these days compared to Section C during which equipment malfunctions occurred which limited the supply of ozone. During optimal operation (Sections A and D), the average ammonia percent removal rate was 20.5% compared to 6.8% in Section C. These results indicate that the pilot unit was operating much more effectively when the ozone output was at a maximum. Section B represents a single data point that is believed to be due to a sampling or labelling error since the ammonia-nitrogen and pH values appear to be reversed.

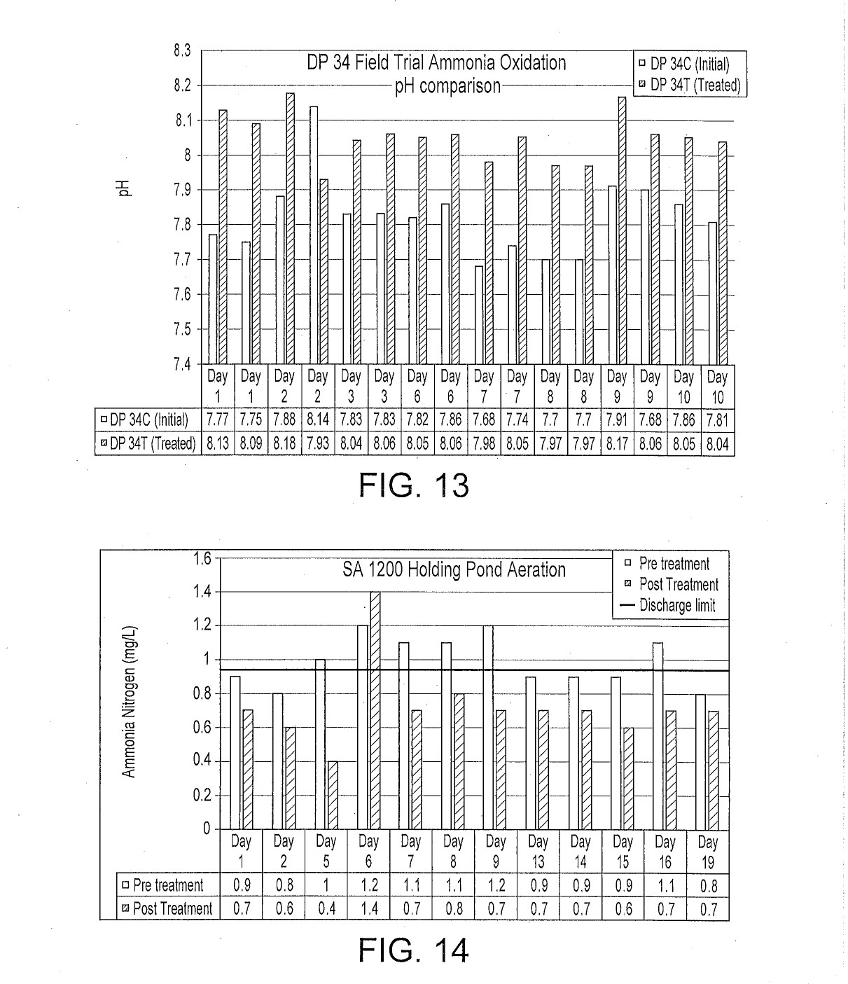

A decrease in overall percentage removal compared to the bench-scale and pilot-scale trials was observed, with an average of 20.5% removal on the actual field test versus 36-37% removal for the pilot-scale test (FIGS. 12-13). Without being bound by any theory, this decrease may have been due to the more complex nature of the basal aquifer water compared to the cleaner city tap water, or to the modified flow-through setup of the field-scale trial compared to the batch treatment method used in the pilot testing. Increased contact time in the treatment tank of the pilot system during the field trials (over 200 minutes) may result in more ammonia interferences due to ozone/oxygen based complexes with ammonium.

### Example 4

### Pond-Scale Aeration of Depressurization Water

A SA 1200 diffusion tower (Seair Diffusion Systems Inc.) was used to aerate depressurization water within a collection pond to volatile off ammonia and initiate biological oxidation. Water collected from the depressurization wells flows to a divided collection pond. The SA 1200 diffusion tower (Seair Diffusion Systems Inc.) draws from the first stage of the pond, and the water is pumped at approximately 18.9 m³/min through the venturi injector (evacuating approximately 14,000 LPM of air into the system) and into the diffusion tower where microbubbles are formed. This aerated water is then splashed onto the rock berm dividing the two stages of the collection pond.

The microbubble atmospheric aeration provides significant biological ammonia oxidation. On average, about 26.9% of the ammonia-nitrogen was removed over a testing period from Jul. 22-Aug. 9, 2010 (FIG. 14). On one day (July 27), the final effluent ammonia-nitrogen concentration was above the monthly average limit of 1 mg/L. It is suspected that this data point may be erroneous. Omitting this data point, the ammonia-nitrogen removal average is 31.8%.

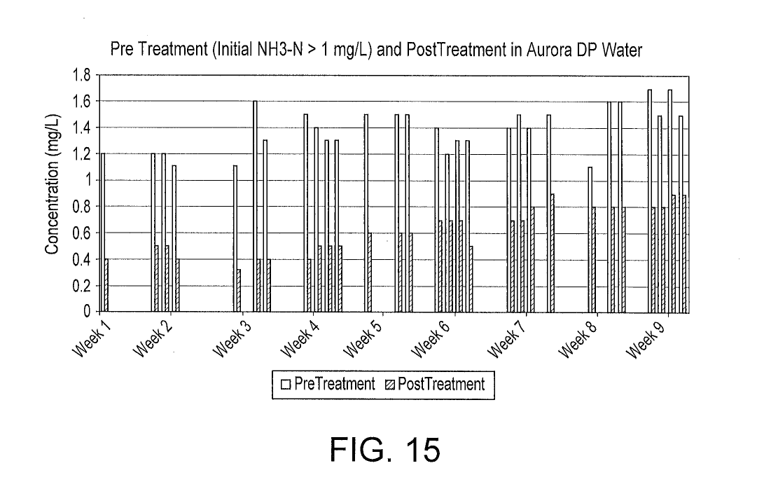

The trial continued until the late fall after which the pond became ice covered. An average reduction of 42% total ammonia over this time period was achieved in the sump depressurization water. The cooler sump water in the fall did not affect the success of total ammonia reduction through aeration. Over the four month test period, total ammonia in the pre-treated depressurization water in the sump varied from 0.1 to 1.7 mg/L NH₃—N(average 0.95 mg/L NH₃—N) (FIG. 15). In the post-treated water, total ammonia varied from 0.2 to 1.4 mg/L NH₃—N(average 0.55 mg/L NH₃—N). At the inlet stillwell prior to discharge, the total ammonia varied from <0.1 to 0.7 mg/L NH₃—N(average<0.5 mg/L), well within the license maximum limits for total ammonia (i.e., 1.0 mg/L monthly average maximum and 2.5 mg/L daily maximum). The analytical detection limit was 0.1 mg/L NH₃—N.

### REFERENCES

The following references are incorporated herein by reference (where permitted) as if reproduced in their entirety. All references are indicative of the level of skill of those skilled in the art to which this invention pertains.
Beltran, F. (2004) Ozone Reaction Kinetics for Water and Wastewater Systems. CRC Press LLC. Boca Raton, Fla.
Hoigne, J. and Bader, H. (1978) Ozonation of water: kinetics of oxidation of ammonia by ozone and hydroxyl radical. Environ. Sci. Technol. 12(1):79-84.
Huang, L.; Li, L.; Dong, W.; Liu, Y. and Hou, H. (2008) Removal of ammonia by OH radial in aqueous phase. Environ. Sci. Technol. 42(21):8070-75.
Wilburn, R. and Wright, T. (2004) SCR ammonia slip distribution in coal plant effluents and dependence on SO₃. Power Plant Chemistry 6(5):295-304.

What is claimed is:

1. A process for removing ammonia from mine depressurization water comprising:
introducing the water into a tank or collection pond;
injecting a sufficient amount of an oxidizing gas into the water to yield aerated water; and
holding the aerated water within the tank or collection pond for a pre-determined residence time to perform air-stripping on the aerated water to facilitate the volatilization of ammonia; nitrification to convert ammonia into nitrate and nitrite; or both.

2. The process of claim 1, wherein the oxidizing gas comprises atmospheric air, pure oxygen, ozone, and mixtures thereof.

3. The process of claim 2, wherein the oxidizing gas comprises ozone.

4. The process of claim 3, wherein ozone is injected at a rate ranging between about 120 g/hr to about 360 g/hr.

5. The process of claim 2, further comprising degassing the water prior to aeration.

6. The process of claim 2, further comprising applying UV radiation to irradiate the water.

7. The process of claim 6, wherein the UV radiation has a wavelength of about 245 nm.

8. The process of claim 2, further comprising adjusting the pH of the water by addition of a base in a quantity sufficient to result in a pH of about 8.0.

9. The process of claim 2, wherein the residence time is at least about three hours.
